(19) United States
(12) Patent Application Publication
(10) Pub. No.: US 2012/0105566 A1
(43) Pub. Date: May 3, 2012

(54) PRINTER, PRINT SYSTEM AND PRINTING METHOD

(75) Inventors: Hiroyasu Ishii, Shizuoka (JP); Chikahiro Saegusa, Shizuoka (JP); Kiyoshi Morino, Shizuoka (JP); Hajime Yamamoto, Shizuoka (JP); Shuji Koyama, Shizuoka (JP); Koji Tomita, Kanagawa (JP)

(73) Assignee: TOSHIBA TEC KABUSHIKI KAISHA, Tokyo (JP)

(21) Appl. No.: 13/270,326

(22) Filed: Oct. 11, 2011

(30) Foreign Application Priority Data
Oct. 29, 2010 (JP) 2010-244525
Oct. 29, 2010 (JP) 2010-244526
Mar. 3, 2011 (JP) 2011-046495
Jun. 7, 2011 (JP) 2011-127633

(51) Int. Cl. B41J 2/325

(52) U.S. Cl. 347/217

(57) ABSTRACT

According to one embodiment, a printer includes a conveying mechanism, a first image forming unit and a coloring conversion mechanism. The conveying mechanism conveys a medium. The first image forming unit forms an image on the medium with a temperature-sensitive ink whose color changes depending on temperature. The coloring conversion mechanism converts a coloring state of the image with the temperature-sensitive ink by heating or cooling the image with the temperature-sensitive ink.

### CROSS-REFERENCE TO RELATED APPLICATIONS

This application is based upon and claims the benefit of priority from Japanese Patent Application No. 2010-244525, filed on Oct. 29, 2010, Japanese Patent Application No. 2010-244526, filed on Oct. 29, 2010, Japanese Patent Application No. 2011-46495, filed on Mar. 3, 2011 and Japanese Patent Application No. 2011-127633, filed on Jun. 7, 2011, the entire contents of which are incorporated herein by reference.

### FIELD

Embodiments described herein relate generally to a printer, a print system and a printing method.

### BACKGROUND

There is conventionally known a printer including a plurality of print heads as image forming units for forming images on a medium. In the printer of this type, the image forming units can form different ink images on the medium. As an example of inks, there is known a temperature-sensitive ink that changes color depending on the temperature thereof.

In the printer referred to above, it is desirable that, when forming temperature-sensitive ink images on a medium, trouble is hardly caused due to the color change of a temperature-sensitive ink.

### BRIEF DESCRIPTION OF THE DRAWINGS

FIG. 1 is a side view showing a schematic configuration of a printer according to a first embodiment.

FIGS. 2A and 2B are explanatory views illustrating one example of the temperature-sensitive properties of a temperature-sensitive ink, FIG. 2A depicting the discoloring property of a temperature-sensitive ink having one threshold temperature and FIG. 2B depicting the discoloring property of a temperature-sensitive ink having two threshold temperatures.

FIG. 3 is a front view showing a cooling mechanism included in the printer of the first embodiment.

FIGS. 4A and 4B are section views showing a spouting portion included in the cooling mechanism shown in FIG. 3, FIG. 4A illustrating a state in which a gas is spouted at a right angle with respect to a medium and FIG. 4B illustrating a state in which the gas is obliquely spouted with respect to the medium.

FIG. 5 is a plan view of a portion of the spouting portion of the cooling mechanism shown in FIG. 3, when seen from a front surface of a backing paper.

FIG. 6 is a block diagram showing one example of a control circuit included in the printer of the first embodiment.

FIG. 7 is a block diagram showing one example of a CPU included in the printer of the first embodiment.

FIGS. 8A and 8B are views showing one example of a product label as a medium obtained in the printer of the first embodiment, FIG. 8A illustrating a state in which images with a temperature-sensitive ink are hard to see (invisible) and FIG. 8B illustrating a state in which images with a temperature-sensitive ink are easy to see (visible).

FIGS. 9A and 9B are side views schematically showing portions of ink ribbon cartridges included in the printer of the first embodiment, FIG. 9A illustrating an ink ribbon cartridge having a long contact section over which an ink ribbon makes contact with a medium and FIG. 9B illustrating an ink ribbon cartridge having a short contact section over which an ink ribbon makes contact with a medium.

FIG. 10 is a plan view showing a movable plate included in a printer according to a modified example of the first embodiment.

FIG. 11 is a view showing one example of a product label as a medium obtained in the printer according to a modified example of the first embodiment.

FIGS. 12A through 12C are views showing one example of a product label as a medium obtained in a printer according to a second embodiment, FIG. 12A illustrating a state in which images with a non-temperature-sensitive ink are formed over images with a temperature-sensitive ink, FIG. 12B illustrating a state in which the images of the non-temperature-sensitive ink is removed and the images of the temperature-sensitive ink are easy to see (visible) and FIG. 12C illustrating a state in which the images of the non-temperature-sensitive ink is removed and the images of the temperature-sensitive ink are hard to see (invisible).

FIGS. 13A and 13B are side views schematically showing portions of ink ribbon cartridges included in the printer of the second embodiment, FIG. 13A illustrating an ink ribbon cartridge having a long contact section over which an ink ribbon makes contact with a medium and FIG. 13B illustrating an ink ribbon cartridge having a short contact section over which an ink ribbon makes contact with a medium.

FIG. 14 is a view showing one example of a product label as a medium obtained in the printer according to a modified example of the second embodiment.

FIG. 15 is a view showing a schematic configuration of an ink ribbon cartridge having an ink ribbon of a non-temperature-sensitive ink or a temperature-sensitive ink employed in a printer according to a third embodiment.

FIG. 16 is a view showing a schematic configuration of an ink ribbon cartridge having an ink ribbon of a heat-insulating ink employed in the printer of the third embodiment.

FIG. 17 is a view illustrating a cross section of the ink ribbon of the heat-insulating ink.

FIGS. 18A and 18B are views showing one example of a product label as a medium obtained in the printer of the third embodiment, FIG. 18A illustrating a product label as a medium outputted from the printer with no cooling performed by a cooling mechanism and FIG. 18B illustrating a product label as a medium outputted from the printer with cooling performed by the cooling mechanism.

FIG. 19 is a section view showing a product label as a medium obtained in the printer of the third embodiment.

FIG. 20 is a flowchart illustrating a flow of a process for forming images such as letters or pictures on a medium under the operation of a print control unit.

FIG. 21 is a view showing one example of a product label as a medium obtained in the printer according to a modified example of the third embodiment.

FIG. 22 is a side view showing a schematic configuration of a printer according to a fourth embodiment.

FIG. 23 is a view showing a schematic configuration of a print system according to a fifth embodiment.

### DETAILED DESCRIPTION

According to one embodiment, a printer includes a conveying mechanism, a first image forming unit and a coloring conversion mechanism. The conveying mechanism conveys a medium. The first image forming unit forms an image on the medium with a temperature-sensitive ink whose color changes depending on temperature. The coloring conversion mechanism converts a coloring state of the image with the temperature-sensitive ink by heating or cooling the image with the temperature-sensitive ink.

Certain embodiments will now be described in detail with reference to the drawings. The embodiments described below include like components. In the following description, like components will be designated by common reference symbols and will not be described repeatedly.

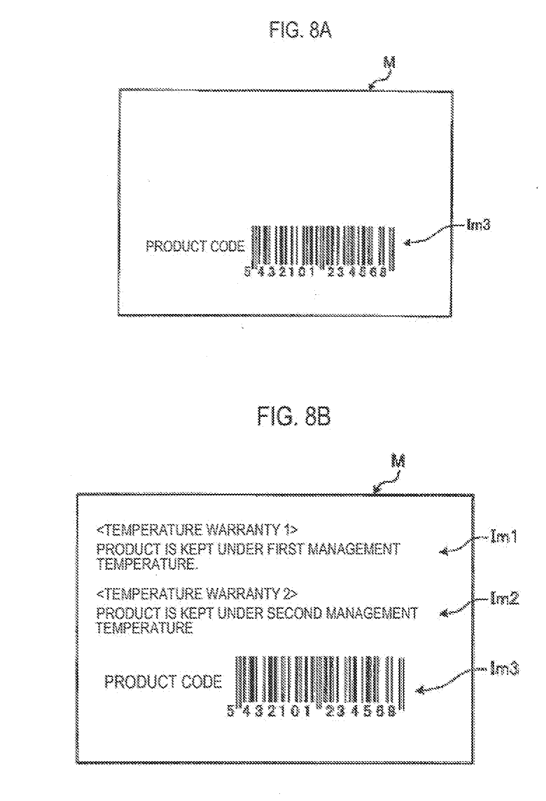

In a first embodiment, a printer 1 is made up of, e.g., a thermal printer configured to heat an ink ribbon and transfer an ink to a medium M such as a paper. The medium M may be, e.g., a label like the one shown in FIG. 8. A plurality of media M is attached to a surface of a strip-shaped backing paper 2 at a specified interval (pitch). Notches may be formed on the backing paper 2 so that the media M can be cut away from the backing paper 2.

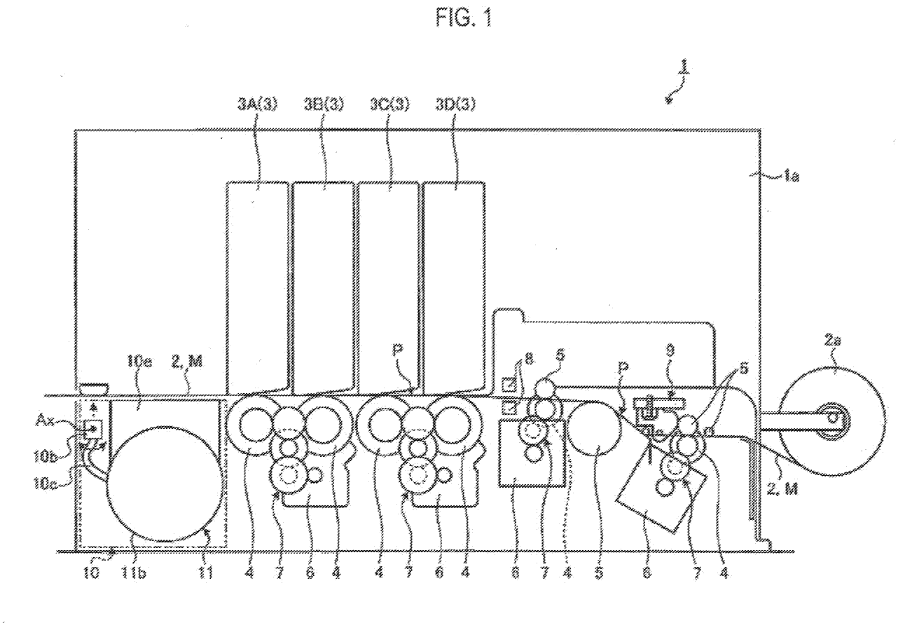

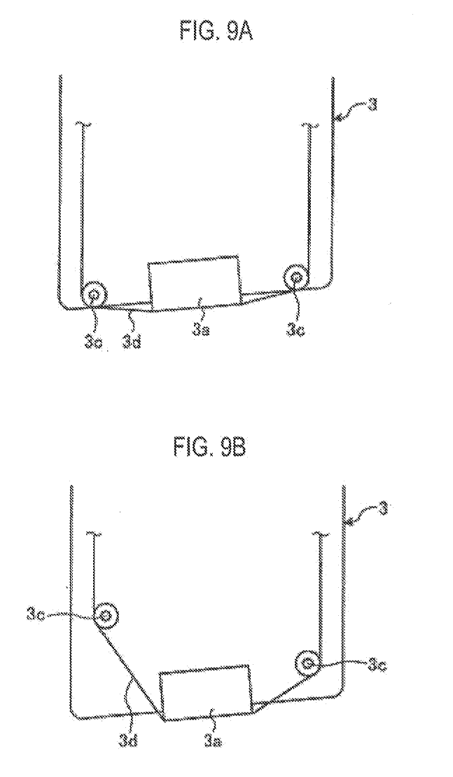

The printer 1 includes a body unit 1a to which a plurality of (four, in the present embodiment) ink ribbon cartridges 3 (3A through 3D) can be attached in a removable manner. The ink ribbon cartridges 3 are arranged side by side along a conveyance path P of the strip-shaped backing paper 2 defined inside the printer 1. Each of the ink ribbon cartridges 3 includes a head (thermal head) 3a and an ink ribbon 3d (see FIGS. 9A and 9B). By causing the head 3a to heat the ink of the ink ribbon 3d, each of the ink ribbon cartridges 3 forms ink images (not shown in FIG. 1) on the medium M conveyed along the conveyance path P. In other words, the head (thermal head) 3a of each of the ink ribbon cartridges 3 corresponds to an image forming unit. The number of the ink ribbon cartridges 3 is not limited to four but may be set differently.

A roll 2a of the backing paper 2 is removably and rotatably mounted to the body unit 1a at the most upstream side of the conveyance path P. Upon rotation of conveying rollers 4, the backing paper 2 is drawn away from the roll 2a and conveyed through the conveyance path P.

The conveyance path P is defined not only by the arrangement of the ink ribbon cartridges 3 but also by the arrangement of the conveying rollers 4 and auxiliary rollers 5. The printer 1 includes a plurality of conveying rollers 4 rotationally driven by a motor 6. Rotation of the motor 6 is transmitted to the respective conveying rollers 4 through a rotation-transmitting mechanism (or a speed-reducing mechanism) 7. The printer 1 includes auxiliary rollers 5 arranged in such positions that the auxiliary rollers 5 pinch the backing paper 2 in cooperation with the conveying rollers 4 or in such positions that the backing paper 2 is stretched between the conveying rollers 4 or between the auxiliary rollers 5. The printer 1 further includes a sensor 8 for detecting the medium M and a tension detecting mechanism 9 for detecting the tension of the backing paper 2. In the present embodiment, the motor 6, the rotation-transmitting mechanism 7, the conveying rollers 4 and the auxiliary rollers 5 make up a conveying mechanism for conveying the backing paper 2 (the medium M).

The printer 1 can be mounted with an ink ribbon cartridge 3 having an ink ribbon of a non-temperature-sensitive ink whose color is not changed depending on a temperature. In addition, the printer 1 can be mounted with an ink ribbon cartridge 3 having an ink ribbon of a temperature-sensitive ink whose color is changed depending on a temperature. Moreover, the printer 1 can be mounted with an ink ribbon cartridge 3 having a differently-colored ink ribbon (with a non-temperature-sensitive ink and a temperature-sensitive ink). Each of the ink ribbon cartridges 3 can be removably mounted in one of the mounting positions of the ink ribbon cartridges 3 (3A through 3D) provided in the body unit 1a.

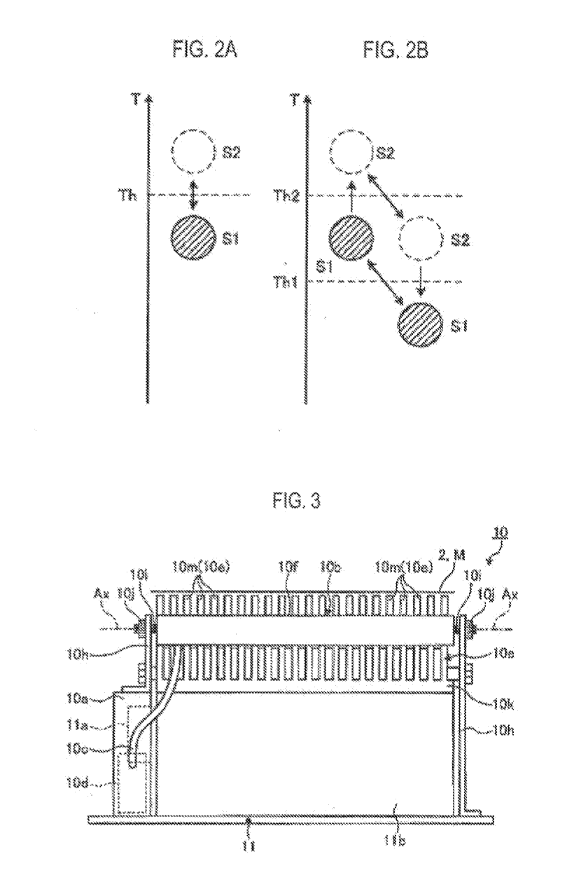

Among the temperature-sensitive inks is an ink whose coloring state varies above and below a threshold temperature Th as depicted in FIG. 2A. For example, the temperature-sensitive ink depicted in FIG. 2A becomes white (S2) if the temperature T exceeds the threshold temperature Th but is colored (S1) if the temperature T is equal to or lower than the threshold temperature Th. If the medium M is a white color and the temperature-sensitive ink remains white (S2), the temperature-sensitive ink images formed on the medium M are hard to see or invisible. The temperature-dependent change of the coloring state of the temperature-sensitive ink is reversible.

Among the temperature-sensitive inks, there is also an ink whose coloring state varies above and below two different threshold temperatures Th1 and Th2 when the temperature T goes up and down as depicted in FIG. 2B. For example, the temperature-sensitive ink depicted in FIG. 2B remains white (S2) if the temperature T, when going down, is higher than a first threshold temperature Th1 but is colored (S1) if the temperature T, when going down, becomes equal to or lower than the first threshold temperature Th1. If the medium M is a white color and the temperature-sensitive ink remains white (S2), the temperature-sensitive ink images formed on the medium M are hard to see or invisible. The temperature-sensitive ink depicted in FIG. 2B remains colored (S1) if the temperature T, when going up, is equal to or lower than a second threshold temperature Th2 but becomes white (S2) if the temperature T, when going up, grows higher than the second threshold temperature Th2. In this regard, the second threshold temperature Th2 is higher than the first threshold temperature Th1 as can be seen in FIG. 2B. Therefore, as long as the temperature T remains between the first threshold temperature Th1 and the second threshold temperature Th2, the coloring state of the temperature-sensitive ink in the falling process of the temperature T differs from the coloring state of the temperature-sensitive ink in the rising process of the temperature T. Since many different kinds of temperature-sensitive inks are available, it is possible to appropriately change the threshold temperatures Th, Th1 and Th2 and the coloring states.

In the case of a thermal printer, the temperature T goes up during an image forming process (heat transfer process). Therefore, if images with a temperature-sensitive ink whose color is changed to the same color as the medium M at a temperature higher that the threshold temperatures Th, Th1 and Th2 mentioned above are formed on the medium M through the use of the printer 1, it is often impossible or difficult to determine whether the temperature-sensitive ink images are successfully formed on the medium M. Depending on the kinds of temperature-sensitive inks, it is sometimes the case that the temperature-sensitive ink images formed on the medium M are hardly visible at a normal temperature. In view of this, the printer 1 of the present embodiment includes a cooling mechanism 10 that serves as a coloring conversion mechanism for converting the coloring state of temperature-sensitive ink images formed on the medium M. In the present embodiment, the temperature T is reduced by, e.g., cooling the temperature-sensitive ink images with the cooling mechanism 10. Thus, the temperature-sensitive ink images get visualized and become readily visible, thereby making it easy to check the formation situation of the temperature-sensitive ink images on the medium M. In other words, the cooling mechanism 10 may be said to be a coloring conversion mechanism or a visualizing mechanism of temperature-sensitive ink images. In the present embodiment, a cooling mechanism provided in the printer 1 may be a feature different from generally available commercial printers, since a cooling mechanism is not usually provided in a general printer. That is, it has not been tried to provide a cooling mechanism in a thermal printer that is used to perform printing in a state of high temperature.

In the present embodiment, the cooling mechanism 10 is configured to spout, e.g., a gas, and reduce the temperature of the medium M, namely the temperature of the temperature-sensitive ink images, using the adiabatic expansion or the latent heat of the gas. More specifically, the cooling mechanism 10 includes a mounting portion 10a for holding a gas cartridge 11 of a gas cylinder, a spouting portion 10b, a tube 10c, a valve 10d and a cooling fin 10e.

The gas cartridge 11 is removably mounted to the mounting portion 10a. The mounting portion 10a serves as a connector for receiving a connector 11a of the gas cartridge 11. The mounting portion 10a may include a movable lever (not shown) used in removing the gas cartridge 11 and a lock mechanism (not shown) for fixing the gas cartridge 11 in a mounting position.

The gas cartridge 11 may be made up of, e.g., a gas cylinder (gas bomb) filled with a liquefied gas. As the gas (coolant), it is possible to use, e.g., tetrafluoroethane.

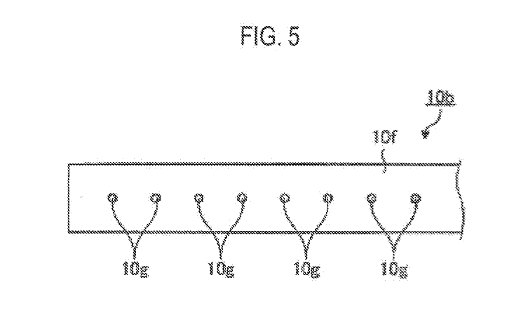

As shown in FIGS. 1 and 3, the spouting portion 10b is arranged to extend in the width direction of the backing paper 2 along the rear surface of the backing paper 2. The spouting portion 10b is a gas pipe having a gas flow path formed therein. Referring to FIG. 5, the spouting portion 10b has an upper wall 10f and a plurality of nozzle holes 10g formed side by side in the upper wall 10f at a regular interval (pitch). The gas is spouted from the nozzle holes 10g toward the rear surface of the backing paper 2. The nozzle holes 10g may be arranged in plural rows.

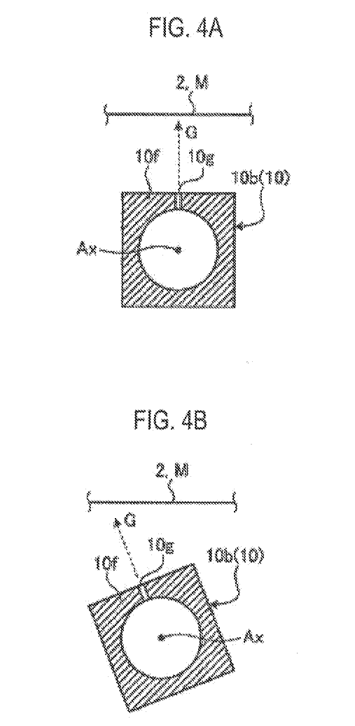

The spouting portion 10b is supported by brackets 10h to rotate about a rotation axis Ax extending in the width direction of the backing paper 2 and is capable of changing the spouting angle (spouting direction) of the gas G as illustrated in FIGS. 4A and 4B. More specifically, as shown in FIG. 3, the spouting portion 10b can be fixed at an arbitrary angle by arranging the spouting portion 10b at a specified spouting angle and then tightening nuts 10j to the male screw portions 10i of the spouting portion 10b inserted into the through-holes (not shown) of the brackets 10h. The cooling degree of the backing paper 2 cooled by the gas G can be variably set by variably setting the spouting angle. For instance, cooling is more heavily performed in the arrangement shown in FIG. 4A than in the arrangement shown in FIG. 4B. Thus, the temperature-sensitive ink images formed on the medium M have a lower temperature in the arrangement shown in FIG. 4A than in the arrangement shown in FIG. 4B. In the present embodiment, the spouting portion 10b includes a spouting condition adjusting mechanism as set forth above.

The tube 10c has pressure resistance and flexibility required for the tube 10c to serve as a gas conduit between the mounting portion 10a and the spouting portion 10b regardless of the change of the angle of the spouting portion 10b.

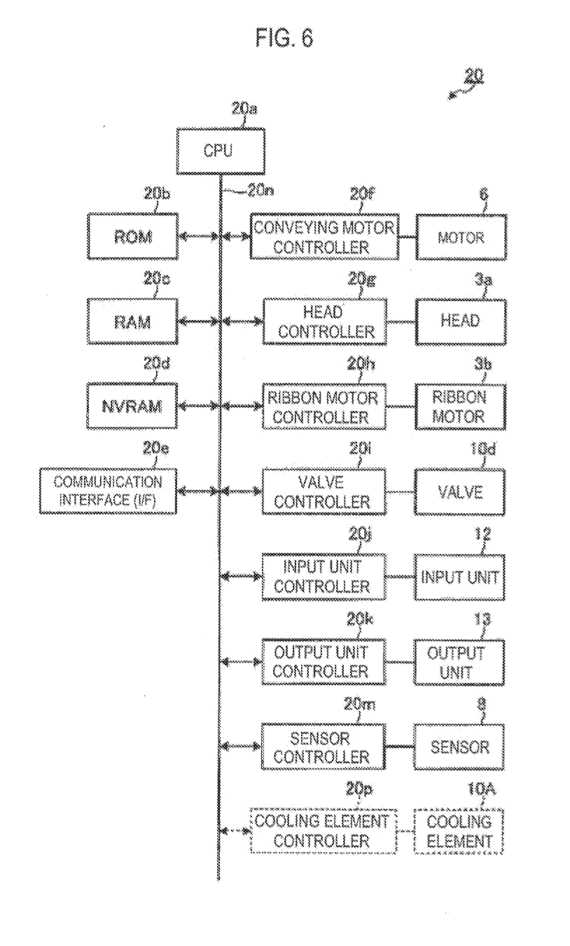

The valve 10d can switch the spouting of the gas from the spouting portion 10b and the blocking of the gas by opening or closing a gas flow path extending from the gas cartridge 11 to the spouting portion 10. The valve 10d may be made up of, e.g., a solenoid valve which is opened in response to an electric signal supplied from a CPU 20a (see FIG. 6). The valve 10d can be attached to the mounting portion 10a. The spouting condition of the gas can be variably set by controlling the opening and closing of the valve 10d (e.g., the length of opening time, the number of repetition of opening and closing, and the period of repetition of opening and closing).

The cooling fin 10e includes a base portion 10k close to or adjoining the outer circumferential surface 11b of the gas cartridge 11 and a plurality of plate-shaped portions 10m extending in the conveying direction and protruding from the base portion 10k toward positions near the rear surface of the backing paper 2. When the temperature of the gas cartridge 11 is reduced by spouting the gas, the cooling fin 10e can enhance the cooling performance for the medium M. The cooling mechanism 10 can be removably mounted to the body unit 1a.

Referring to FIG. 6, the control circuit 20 of the printer 1 includes a CPU (Central Processing Unit) 20a as a control unit, a ROM (Read Only Memory) 20b, a RAM (Random Access Memory) 20c, an NVRAM (Non-Volatile Random Access Memory) 20d, a communication interface (I/F) 20e, a conveying motor controller 20f, a head controller 20g, a ribbon motor controller 20h, a valve controller 20i, an input unit controller 20j, an output unit controller 20k and a sensor controller 20m, all of which are connected to one another through a bus 20n such as an address bus or a data bus.

The CPU 20a controls each unit of the printer 1 by executing various kinds of computer-readable programs stored in the ROM 20b or other places. The ROM 20b stores, e.g., various kinds of data processed by the CPU 20a and various kinds of programs (such as a basic input/output system abbreviated as BIOS, an application program and a device driver program) executed by the CPU 20a. The RAM 20c temporarily stores data and programs while the CPU 20a executes various kinds of programs. The NVRAM 20d stores, e.g., an OS (Operating System), an application program, a device driver program and various kinds of data which are to be kept intact even when the power is turned off.

The communication interface (I/F) 20e controls data communication with other devices connected through telecommunication lines.

The conveying motor controller 20f controls the motor 6 pursuant to an instruction supplied from the CPU 20a. The head controller 20g controls the head 3a (see FIG. 9) in response to an instruction supplied from the CPU 20a. The ribbon motor controller 20h controls a ribbon motor 3b built in each of the ink ribbon cartridges 3 according to an instruction supplied from the CPU 20a. The valve controller 20i controls the valve 10d (the solenoid of the valve 10d) of the cooling mechanism 10 based on an instruction supplied from the CPU 20a.

The input unit controller 20j transmits to the CPU 20a signals inputted through an input unit 12 (e.g., push buttons, a touch panel, a keyboard, a microphone, knobs or DIP switches) for inputting manual operations or voices of a user. The output unit controller 20k controls an output unit 13 (e.g., a display, a light-emitting unit a speaker or a buzzer) for outputting images or voices pursuant to an instruction supplied from the CPU 20a. The sensor controller 20m transmits to the CPU 20a a signal indicative of the detection result of a sensor 8.

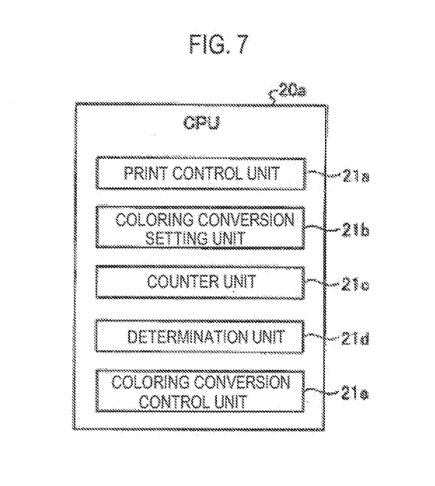

Turning to FIG. 7, the CPU 20a as a control unit works as a print control unit 21a, a coloring conversion setting unit 21b, a counter unit 21c, a determination unit 21d and a coloring conversion control unit 21e according to the programs executed. The programs contain modules corresponding to at least the print control unit 21a, the coloring conversion setting unit 21b, the counter unit 21c, the determination unit 21d and the coloring conversion control unit 21e.

The print control unit 21a controls the motor 6, the head 3a and the ribbon motor 3b through the conveying motor controller 20f, the head controller 20g and the ribbon motor controller 20h. Images such as letters or pictures are formed on the medium M under the control of the print control unit 21a.

The coloring conversion setting unit 21b performs various kinds of setting operations associated with the coloring conversion of the temperature-sensitive ink images printed on the medium M (the cooling performed by the cooling mechanism 10 in the present embodiment). More specifically, the coloring conversion setting unit 21b can cause the storage unit such as the NVRAM 20d to store a pitch (frequency) at which coloring conversion (cooling) is performed with respect to the medium M and a parameter for setting the opening or closing conditions of the valve 10d (e.g., the opening/closing timing, the opening/closing duration, the number of opening/closing times and the opening/closing time period), which are inputted through the input unit 12.

The counter unit 21c counts the number of the media M (or the number of image formation areas) detected by the sensor 8. The determination unit 21d compares the count value counted by the counter unit 21c with the pitch (frequency) stored in the storage unit and determines whether to perform coloring conversion (cooling in the present embodiment). The coloring conversion control unit 21e controls each part or unit (the respective parts of the cooling mechanism 10 in the present embodiment) in order to perform coloring conversion (cooling in the present embodiment) with respect to the medium M (the temperature-sensitive ink images formed on the medium M) that is determined to be subjected to coloring conversion. In the present embodiment, the coloring conversion control unit 21e performs the coloring conversion of the medium M by controlling the opening/closing state of the valve 10d and consequently controlling the spouting condition of the gas. The coloring conversion control unit 21e also corresponds to a spouting condition adjusting mechanism. In the present embodiment, pursuant to the setting of the pitch (frequency), the coloring conversion can be performed with respect to the temperature-sensitive ink images formed on all the media M or some of the media M.

The printer 1 configured as above can produce, e.g., a medium M as illustrated in FIG. 8A or 8B. FIG. 8A illustrates a product label as a medium M outputted from the printer 1 with no cooling performed by the cooling mechanism 10. FIG. 8B illustrates a product label as a medium M outputted from the printer 1 with the cooling performed by the cooling mechanism 10. The temperature-sensitive ink images Im1 and Im2 are visualized when the cooling is performed by the cooling mechanism 10. Accordingly, a user or an operator of the printer 1 is easily able to visually recognize the formation of the temperature-sensitive ink images Im1 and Im2 on the medium M. FIGS. 8A and 8B illustrate a case where images Im1 and Im2 of two kinds of temperature-sensitive inks differing in threshold temperature Th are formed on the medium M. Moreover, an image Im3 (e.g., a barcode) formed by a typical ink whose coloring state is not changed by the temperature is also formed on the medium M.

As one example, the medium M illustrated in FIGS. 8A and 8B can be used for temperature management when refrigerating or freezing a product. More specifically, the medium M on which the images Im1 and Im2 of the temperature-sensitive ink having the temperature-sensitive property depicted in FIG. 2A formed by the printer 1 is used as a product label. The printer 1 utilizes a temperature-sensitive ink having a threshold temperature Th equal to a management temperature (e.g., 5 degrees Celsius) that a product to be refrigerated or frozen is not allowed to exceed. As a result, if a product temperature exceeds the threshold temperature Th, the medium M comes into the state as illustrated in FIG. 8A. Thus, the temperature-sensitive ink images Im1 and Im2 become hard to see or invisible (S2 in FIG. 2A). On the other hand, if the product temperature is equal to or lower than the threshold temperature Th as the management temperature, the medium M is kept in the state illustrated in FIG. 8B (S1 in FIG. 2A). This enables a worker or other persons to determine whether the product temperature is higher than or lower than the management temperature, based on whether the temperature-sensitive ink images Im1 and Im2 are easy to see (visible) or hard to see (invisible). In the example illustrated in FIGS. 8A and 8B, the images Im1 and Im2 of two kinds of temperature-sensitive inks differing in the threshold temperature Th are formed on the medium M to thereby indicate the product management results in respect of two kinds of management temperatures (first and second management temperatures). In this example, the formation condition of the temperature-sensitive ink images Im1 and Im2 on the medium M can be visually confirmed by cooling the medium M with the cooling mechanism 10.

As another example, images Im1 and Im2 of a temperature-sensitive ink with a temperature-sensitive property showing a hysteresis in temperature rising and falling processes as depicted in FIG. 2B can be formed by the printer 1 on a product label as a medium M illustrated in FIGS. 8A and 8B. In this case, the printer 1 forms the images Im1 and Im2 on the medium M through the use of a temperature-sensitive ink having a threshold temperature Th2 equal to a management temperature (e.g., −5 degrees Celsius) that a product to be refrigerated or frozen is not allowed to exceed and a threshold temperature Th1 equal to a temperature (e.g., −30 degrees Celsius) that cannot be realized in a specified refrigerating or freezing state. In the printer 1, the cooling mechanism 10 cools the images Im1 and Im2 to the threshold temperature Th1 or lower (e.g., −40 degrees Celsius) so that the images Im1 and Im2 formed by the printer 1 can be visualized on the medium M. In the case of this example, all of the media M are cooled by the cooling mechanism 10 to first reduce the temperature of the media M to the threshold temperature Th1 or lower. As a result, if a product temperature exceeds the threshold temperature Th2 as the management temperature even for a single time, the medium M comes into the state illustrated in FIG. 8A. Thus, the temperature-sensitive ink images Im1 and Im2 become hard to see or invisible (S2 in FIG. 2B) and continue to remain in this state (S2). On the other hand, if the product temperature is equal to or lower than the threshold temperature Th2 as the management temperature, the medium M is kept in the state illustrated in FIG. 8B (S1 in FIG. 2B). This enables a worker or other persons to determine whether the product temperature has ever exceeded the management temperature before, based on whether the temperature-sensitive ink images Im1 and Im2 are easy to see (visible) or hard to see (invisible). In this example, the images Im1 and Im2 of two kinds of temperature-sensitive inks differing in the threshold temperature Th2 are formed on the medium M to thereby indicate the product management results in respect of two kinds of management temperatures (first and second management temperatures).

In the printer 1 of the present embodiment, as shown in FIGS. 9A and 9B, it is possible to use ink ribbon cartridges 3 that differ from each other in the positions of the ribbon rollers 3c with respect to the head 3a. In the configuration shown in FIG. 9A, the ink ribbon 3d and the medium M make contact with each other for a long period of time. In the configuration shown in FIG. 9B, the ink ribbon 3d and the medium M make contact with each other for a short period of time. One of these configurations can be selected depending on the properties of the temperature-sensitive ink or the non-temperature-sensitive ink. In the present embodiment, the ink ribbon cartridge 3 corresponds to an ink ribbon holding unit. The ribbon motor 3b and the ribbon rollers 3c make up a ribbon conveying unit.

In the printer 1 of the present embodiment described above, the head 3a of the ink ribbon cartridge 3 as an image forming unit forms temperature-sensitive ink images on the medium M and the cooling mechanism 10 as a coloring conversion mechanism converts the coloring of the images. According to the present embodiment, it is therefore possible to impart desired coloring states to the temperature-sensitive ink images formed on the medium M outputted from the printer 1. It is also easy to confirm whether desired temperature-sensitive ink images are successfully formed on the medium M.

In the present embodiment, the cooling mechanism 10 as a coloring conversion mechanism reduces the temperature of the images by spouting a gas. This makes it possible to obtain the cooling mechanism 10 with a relatively simple configuration.

In the present embodiment, the printer 1 includes, as the spouting condition adjusting mechanism for adjusting the spouting condition of the gas, a mechanism for adjusting the posture of the spouting portion 10b (e.g., the spouting direction of the gas G spouted from the nozzle holes 10g) and a mechanism for variably setting the gas spouting timing or the gas spouting time period (e.g., the opening/closing time period of the valve 10d). This makes it possible to suitably adjust the condition of the cooling performed by the gas.

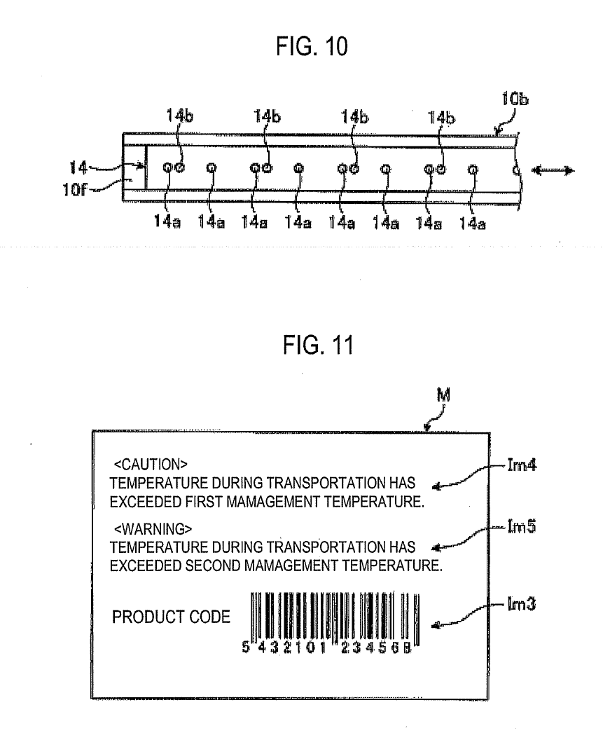

As the spouting condition adjusting mechanism, it is possible to employ, e.g., a movable plate 14 for changing the number of effective nozzle holes 10g as shown in FIG. 10. The movable plate 14 is supported on the upper wall 10f of the spouting portion 10b to movably slide along the upper wall 10f. The movable plate 14 has through-holes 14a overlapping with all of the nozzle holes 10g when the movable plate 14 is in one position and through-holes 14b overlapping with some of the nozzle holes 10g when the movable plate 14 is in another position. By sliding the movable plate 14, it is possible to switch a state in which the gas is spouted from all of the nozzle holes 10g through the through-holes 14a and a state in which the gas is spouted from some of the nozzle holes 10g through the through-holes 14b. This makes it possible to variably set the amount of the spouting gas, thereby variably setting the cooling degree of the temperature-sensitive ink images.

In the present embodiment, the printer 1 includes the heads 3a of the ink ribbon cartridges 3 as a plurality of image forming units for forming images with different temperature-sensitive inks on the medium M. Accordingly, a plurality of ink images differing in temperature-sensitive property can be formed on the medium M, which makes it possible to perform temperature management in multiple stages.

In the present embodiment, the cooling mechanism 10 cools the temperature-sensitive ink image as extracted (selected or designated) and converts the coloring state thereof. This configuration can reduce energy consumption as compared with a case where all the temperature-sensitive ink images are cooled.

In the printer 1, it is also possible to use a temperature-sensitive ink having a property opposite to the property of the temperature-sensitive ink stated above, namely a temperature-sensitive ink having such property that the temperature-sensitive ink is visualized when the temperature thereof exceeds a management temperature. For example, as shown in FIG. 11, if the ink temperature is higher than the threshold temperature, a message of “caution” or “warning” indicating that the temperature of the temperature-sensitive ink image Im4 or Im5 has exceeded the management temperature appears on the medium M as a product label. In this example, images Im4 and Im5 of temperature-sensitive inks differing in the threshold temperature are formed on the medium M, which makes it possible to manage a product at different temperatures. In the printer 1 corresponding to the example shown in FIG. 11, a heating mechanism instead of the cooling mechanism 10 can be provided as the coloring conversion mechanism. In this example, the temperature-sensitive ink images Im4 and Im5 are visualized to issue a caution notice or a warning notice when a specified temperature condition is not satisfied.

In the second embodiment, images of a non-temperature-sensitive ink whose color is not changed depending on a temperature are formed on a medium on which images with a temperature-sensitive ink are formed. Accordingly, when the temperature-sensitive ink images and the non-temperature-sensitive ink images are formed on the medium, the images can be utilized in a more effective manner. Hereinafter, description will be made on points differing from the above-described embodiment. No description will be given on the same points as those of the above-described embodiment.

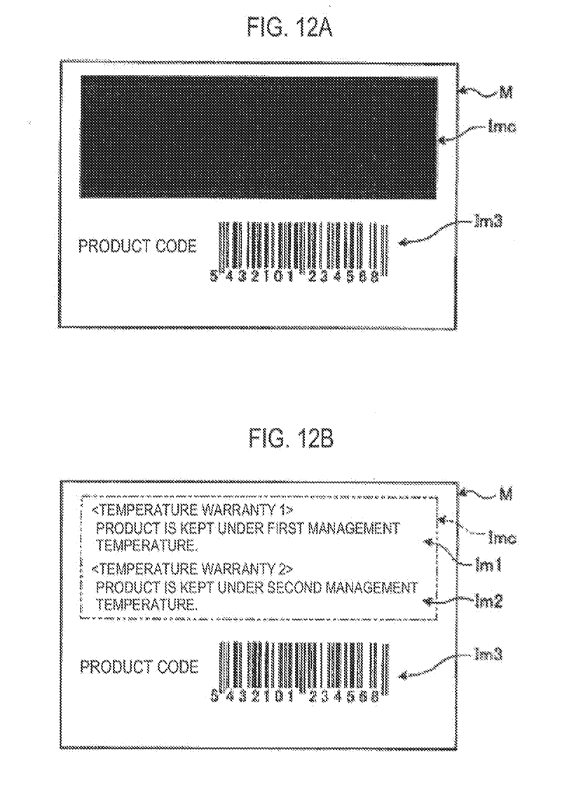

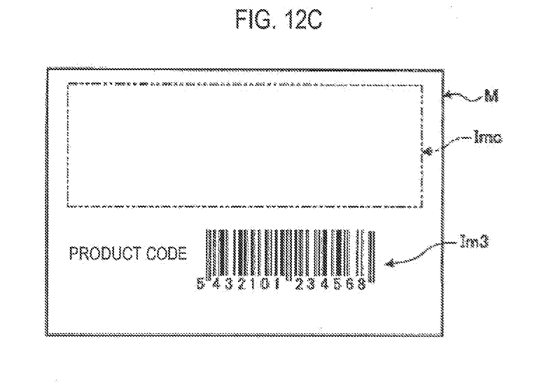

FIGS. 12A through 12C show one example of a product label as a medium M obtained in the printer 1 of the present embodiment. In this example, images Im1 and Im2 of a temperature-sensitive ink and images Im3 and Imc of a non-temperature-sensitive ink are formed on the medium M. FIG. 12A shows the medium M outputted from the printer 1. As is apparent from the comparison with FIG. 12B, the temperature-sensitive ink images Im1 and Im2 are covered with the non-temperature-sensitive ink image Imc and are kept in an invisible state. The non-temperature-sensitive ink image Imc covering the temperature-sensitive ink images Im1 and Im2 is formed in such a state that it can be peeled off in a relatively easy manner. Therefore, a user or other persons can visually recognize the temperature-sensitive ink images Im1 and Im2 by removing, e.g., scraping away, the non-temperature-sensitive ink image Imc covering the temperature-sensitive ink images Im1 and Im2 through the use of a relative hard object such as a coin. The term “non-temperature-sensitive ink” refers to an ink that does not have the temperature-sensitive property like the one of the temperature-sensitive ink.

If the temperature-sensitive ink images Im1 and Im2 are covered with the non-temperature-sensitive ink image Imc, there is an effect of enhancing the protection performance of the temperature-sensitive ink images Im1 and Im2. For example, it can be determined that the indication result of the temperature-sensitive ink images Im1 and Im2 has been confirmed by someone, if the non-temperature-sensitive ink image Imc is removed. This is also effective, e.g., when one wishes to keep confidential the indication result of the temperature-sensitive ink images Im1 and Im2.

The two temperature-sensitive ink images Im1 and Im2 may be formed with two kinds of temperature-sensitive inks differing in the threshold temperatures Th1 and Th2. In this case, the ink ribbon cartridges 3 for forming the temperature-sensitive ink images Im1 and Im2 are independently mounted to the body unit 1a because the inks used differ from each other.

In order to form the non-temperature-sensitive ink image Imc on the medium M on which the temperature-sensitive ink images Im1 and Im2 are formed, the ink ribbon cartridges 3C and 3D for forming the temperature-sensitive ink images Im1 and Im2 are arranged at the upstream side of the conveyance path P in the printer 1 and the ink ribbon cartridge 3A for forming the non-temperature-sensitive ink image Imc is arranged at the downstream side of the conveyance path P in the printer 1. The ink ribbon cartridge 3B for forming the non-temperature-sensitive ink image Im3 that does not cover the temperature-sensitive ink images Im1 and Im2 is arranged between the ink ribbon cartridge 3A for forming the non-temperature-sensitive ink image Imc and the ink ribbon cartridges 3C and 3D for forming the temperature-sensitive ink images Im1 and Im2.

If the images Im1 and Im2 of the temperature-sensitive ink having the properties depicted in FIG. 2A or 2B are not covered with a non-temperature-sensitive ink image, the temperature-sensitive ink images Im1 and Im2 are visualized as the cooling is performed by the cooling mechanism 10. This enables a user of the printer 1 or other persons to visually recognize the formation of the temperature-sensitive ink images Im1 and Im2 on the medium M with ease.

As one example, the medium M illustrated in FIGS. 12A through 12C can be used for temperature management when refrigerating or freezing a product. More specifically, the medium M on which the images Im1 and Im2 of the temperature-sensitive ink having the temperature-sensitive property depicted in FIG. 2A are formed by the printer 1 is used as a product label. The printer 1 utilizes a temperature-sensitive ink having a threshold temperature Th equal to a management temperature (e.g., 5 degrees Celsius) that a product to be refrigerated or frozen is not allowed to exceed. As a result, if a product temperature exceeds the threshold temperature Th, the medium M comes into the state as illustrated in FIG. 12C. Thus, the temperature-sensitive ink images Im1 and Im2 become hard to see or invisible (S2 in FIG. 2A). On the other hand, if the product temperature is equal to or lower than the threshold temperature Th as the management temperature, the medium M is kept in the state illustrated in FIG. 12B (S1 in FIG. 2A). This enables a worker or other persons to determine whether the product temperature is higher than or lower than the management temperature, depending on whether the temperature-sensitive ink images Im1 and Im2 are easy to see (visible) or hard to see (invisible). In the example illustrated in FIGS. 12A through 12C, the images Im1 and Im2 of two kinds of temperature-sensitive inks differing in the threshold temperature Th are formed on the medium M to thereby indicate the product management results in respect of two kinds of management temperatures (first and second management temperatures).

As another example, images Im1 and Im2 of a temperature-sensitive ink with a temperature-sensitive property showing a hysteresis in temperature rising and falling processes as depicted in FIG. 2B can be formed by the printer 1 on a product label as a medium M illustrated in FIGS. 12A through 12C. In this case, the printer 1 forms the images Im1 and Im2 on the medium M through the use of a temperature-sensitive ink having a threshold temperature Th2 equal to a management temperature (e.g., −5 degrees Celsius) that a product to be refrigerated or frozen is not allowed to exceed and a threshold temperature Th1 equal to a temperature (e.g., −30 degrees Celsius) that cannot be realized in a specified refrigerating or freezing state. In the printer 1, the cooling mechanism 10 cools the images Im1 and Im2 to the threshold temperature Th1 or less (e.g., −40 degrees Celsius) so that the images Im1 and Im2 formed by the printer 1 can be visualized on the medium M. In case of this example, all the media M are cooled by the cooling mechanism 10 to first reduce the temperature of the media M to the threshold temperature Th1 or less. As a result, if a product temperature exceeds the threshold temperature Th2 as the management temperature even just once, the medium M comes into the state as illustrated in FIG. 12C. Thus, the temperature-sensitive ink images Im1 and Im2 become hard to see or invisible (S2 in FIG. 2B) and continue to remain in this state (S2). On the other hand, if the product temperature is equal to or lower than the threshold temperature Th2 as the management temperature, the medium M is kept in the state illustrated in FIG. 12B (S1 in FIG. 2B). This enables a worker or other persons to determine whether the product temperature has ever exceeded the management temperature before, depending on whether the temperature-sensitive ink images Im1 and Im2 are easy to see (visible) or hard to see (invisible). In this example, the images Im1 and Im2 of two kinds of temperature-sensitive inks differing in the threshold temperature Th2 are formed on the medium M to thereby indicate the product management results in respect of two kinds of management temperatures (first and second management temperatures).

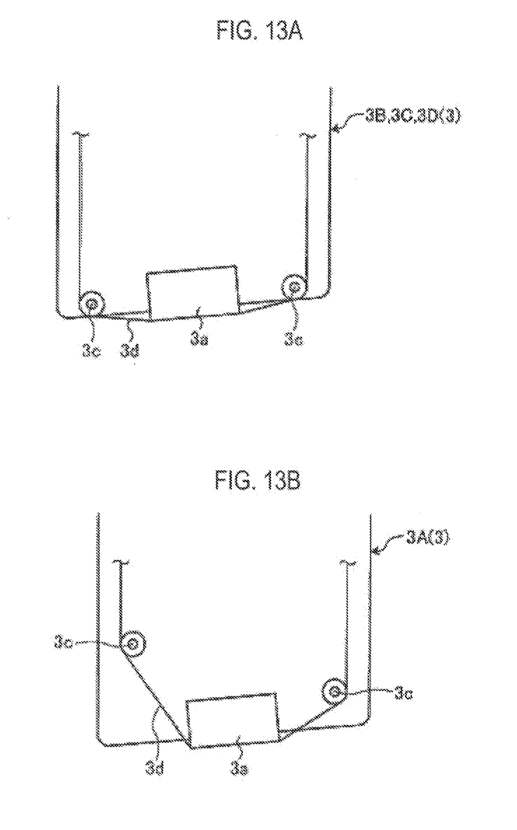

In the printer 1 of the present embodiment, as shown in FIGS. 13A and 13B, it is possible to use ink ribbon cartridges 3 that differ from each other in the positions of the ribbon rollers 3c with respect to the head 3a. In the configuration shown in FIG. 13A, the ink ribbon 3d and the medium M make contact with each other for a long period of time. In the configuration shown in FIG. 13B, the ink ribbon 3d and the medium M make contact with each other for a short period of time. One of these configurations can be selected depending on the properties of the temperature-sensitive ink or the non-temperature-sensitive ink. In the present embodiment, the ink ribbon cartridges 3C and 3D for forming the temperature-sensitive ink images Im1 and Im2 and the ink ribbon cartridge 3B for forming the non-temperature-sensitive ink image Im3 that does not cover the temperature-sensitive ink images Im1 and Im2 may have the configuration shown in FIG. 13A. The ink ribbon cartridge 3A for forming the non-temperature-sensitive ink image Imc that covers the temperature-sensitive ink images Im1 and Im2 may have the configuration shown in FIG. 13B. In this example, the head 3a of the ink ribbon cartridge 3A corresponds to a second image forming unit. In the present embodiment, the ink ribbon cartridges 3 correspond to an ink ribbon holding unit. The ribbon motor 3b and the ribbon rollers 3c make up a ribbon conveying unit.

The inks supplied from the ink ribbons 3d of the ink ribbon cartridges 3 of the present embodiment are largely divided into three kinds of inks; namely a wax type ink, a wax resin type ink (a semi-resin type ink or a wax plus resin-based ink) and a resin type ink (a resin-based ink). Among the three kinds of inks, the wax type ink is most easily scraped away. In the present embodiment, it is therefore preferred that the non-temperature-sensitive ink image Imc covering the temperature-sensitive ink images Im1 and Im2 is formed with an ink ribbon having a wax type ink while the temperature-sensitive ink images Im1 and Im2 and the non-temperature-sensitive ink image Im3 are formed with an ink ribbon having a wax resin type ink or a resin type ink (more preferably, a resin type ink).

According to the printer 1 of the second embodiment described above, the heads 3a of the ink ribbon cartridges 3C and 3D as a first mage forming unit form the temperature-sensitive ink images on the medium M and the head 3a of the ink ribbon cartridge 3A as a second image forming unit forms the non-temperature-sensitive ink image on the medium M on which the temperature-sensitive ink images are formed. Accordingly, when the temperature-sensitive ink images and the non-temperature-sensitive ink images are formed on the medium M, the images can be utilized in a more effective manner.

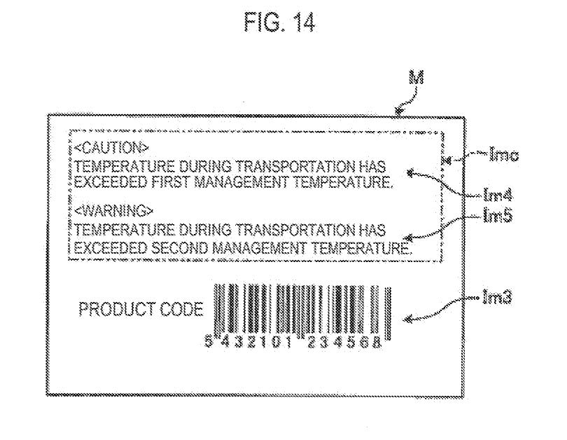

In the printer 1 of the present embodiment, it is also possible to use a temperature-sensitive ink having a property opposite to the property of the temperature-sensitive ink stated above, namely a temperature-sensitive ink having such a property that the temperature-sensitive ink is visualized when the temperature thereof exceeds a management temperature. For example, as shown in FIG. 14, if the ink temperature is higher than the threshold temperature, a message of “caution” or “warning” indicating that the temperature of temperature-sensitive ink image Im4 or Im5 has exceeded the management temperature appears on the medium M as a product label. In this example, images Im4 and Im5 of temperature-sensitive inks differing in the threshold temperature are formed on the medium M, which makes it possible to manage a product at different temperatures. In the printer 1 corresponding to the example shown in FIG. 14, a heating mechanism instead of the cooling mechanism 10 can be provided as the coloring conversion mechanism. In this example, the temperature-sensitive ink images Im4 and Im5 formed on the medium M can be covered with a non-temperature-sensitive ink image Imc.

In the third embodiment, images with a temperature-sensitive ink are formed on a medium and a heat-insulating layer having a thermal insulation property is formed on the medium to cover at least the temperature-sensitive ink images. This makes it possible to prevent the temperature-sensitive ink images from undergoing a color change even when a temperature is changed within a short period of time. Accordingly, it becomes possible to provide a label that can be effectively used as a temperature management means. Hereinafter, description will be made on points differing from the above-described embodiments. No description will be given on the same points as those of the above-described embodiments.

In addition to the ink ribbon cartridge 3 having an ink ribbon of a non-temperature-sensitive ink whose color is not changed depending on a temperature and the ink ribbon cartridge 3 having an ink ribbon of a temperature-sensitive ink whose color is changed depending on a temperature, the printer 1 of the present embodiment can be mounted with a plurality of ink ribbon cartridges 3 each having an ink ribbon of a heat-insulating ink (a heat-insulating member) for formation of a heat-insulating layer with a thermal insulation property, e.g., a layer of resin such as polyethylene terephthalate containing a foaming agent. In the printer 1 of the present embodiment, each of the ink ribbon cartridges 3 can be removably mounted in one of the mounting positions of the ink ribbon cartridges 3 (3A through 3D) provided in the body unit 1a.

In the present embodiment, the ink ribbon cartridge 3D having an ink ribbon 3d of a non-temperature-sensitive ink, the ink ribbon cartridge 3C having an ink ribbon 3d of a temperature-sensitive ink, the ink ribbon cartridge 3B having an ink ribbon 3d of a temperature-sensitive ink and the ink ribbon cartridge 3A having an ink ribbon 3d of a heat-insulating ink are mounted in the named order from the upstream side of the conveyance path P along which the medium M is conveyed.

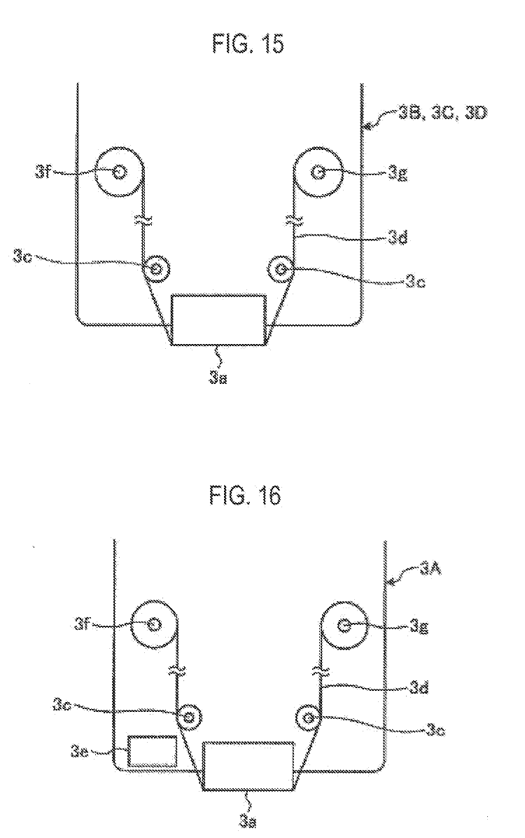

FIG. 15 is a view showing a schematic configuration of the ink ribbon cartridges 3B, 3C and 3D each having an ink ribbon 3d of a non-temperature-sensitive ink or a temperature-sensitive ink. As shown in FIG. 15, each of the ink ribbon cartridges 3B, 3C and 3D includes a head 3a for heating the non-temperature-sensitive ink or the temperature-sensitive ink contained in the ink ribbon 3d to form images of the non-temperature-sensitive ink or the temperature-sensitive ink on the medium M conveyed along the conveyance path P. In the present embodiment, the heads 3a of the ink ribbon cartridges 3B and 3C correspond to an image forming unit for forming images with a temperature-sensitive ink on the medium M. As shown in FIG. 15, each of the ink ribbon cartridges 3B, 3C and 3D further includes a supply roller 3g wound with the ink ribbon 3d from which the non-temperature-sensitive ink or the temperature-sensitive ink is not yet supplied to the medium M and a take-up roller 3f wound with the ink ribbon 3d from which the non-temperature-sensitive ink or the temperature-sensitive ink has been supplied to the medium M. The ink ribbon 3d wound around the supply roller 3g is conveyed to the head 3a by ribbon rollers 3c. After supplying the non-temperature-sensitive ink or the temperature-sensitive ink to the medium M, the ink ribbon 3d is conveyed to the take-up roller 3f.

In the foregoing embodiments, description has been made on the temperature-sensitive ink whose temperature-dependent coloring state is reversibly changed (see FIG. 2A). Alternatively, it may be possible to use a temperature-sensitive ink whose temperature-dependent coloring state is irreversibly changed. The temperature-sensitive ink whose temperature-dependent coloring state is irreversibly changed (hereinafter referred to as “memory-type temperature-sensitive ink”) refers to an ink that does not come back to an original state if the coloring state thereof is changed above or below a threshold temperature Th. For example, if the memory-type temperature-sensitive ink is changed from a colored state (S1 in FIG. 2A) to a white state (S2 in FIG. 2A) as the temperature T becomes higher than the threshold temperature Th depicted in FIG. 2A, the memory-type temperature-sensitive ink does not come back to the colored state (S1 in FIG. 2A).

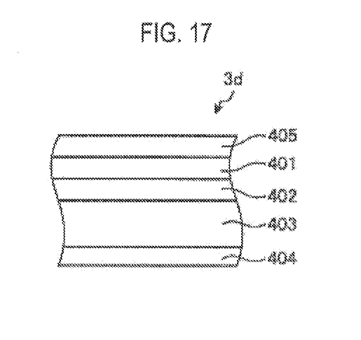

FIG. 16 is a view showing a schematic configuration of the ink ribbon cartridge 3A having an ink ribbon 3d of a heat-insulating ink. FIG. 17 is a view illustrating a cross section of the ink ribbon 3d of the heat-insulating ink. As shown in FIG. 16, the ink ribbon cartridge 3A includes a head 3a for heating the heat-insulating ink contained in the ink ribbon 3d to form an image of the heat-insulating ink so as to cover the images of the temperature-sensitive ink formed on the medium M by the ink ribbon cartridges 3B and 3C and a foaming unit 3e for heating the image of the heat-insulating ink formed by the head 3a to form a foam layer in which the foaming agent contained in the heat-insulating ink is foamed, namely a heat-insulating layer with a thermal insulation property. In the present embodiment, the head 3a and the foaming unit 3e of the ink ribbon cartridge 3A correspond, to a heat-insulating layer forming unit for forming the heat-insulating layer with a thermal insulation property on the medium M to cover at least the images of the temperature-sensitive ink.

In the present embodiment, the foam layer in which the foaming agent contained in the heat-insulating ink is foamed, namely the heat-insulating layer with a thermal insulation property, is formed by heating the image of the heat-insulating ink formed by the head 3a. However, the present disclosure is not limited thereto. As another example, instead of using the heat-insulating layer forming unit made up of the head 3a and the foaming unit 3e, it may be possible to employ a heat-insulating layer forming unit that forms a heat-insulating layer by affixing a seal-shaped member with a thermal insulation property to cover the images of the temperature-sensitive ink formed on the medium M by the ink ribbon cartridges 3B and 3C. If the affixing position of the seal-shaped member with a thermal insulation property is predetermined on the medium M having the images of the temperature-sensitive ink, the heat-insulating layer forming unit affixes a seal-shaped member whose size and shape correspond to the predetermined affixing position. When affixing the seal-shaped member with a thermal insulation property, the heat-insulating layer forming unit may affix the seal-shaped member so as to cover the entire area or the almost entire area of the medium M.

As shown in FIG. 16, the ink ribbon cartridge 3A further includes a supply roller 3g wound with the ink ribbon 3d from which the heat-insulating ink is not yet supplied to the medium M and a take-up roller 3f wound with the ink ribbon 3d from which the heat-insulating ink has been supplied to the medium M. The ink ribbon 3d wound around the supply roller 3g is conveyed to the head 3a by ribbon rollers 3c. After supplying the heat-insulating ink to the medium M, the ink ribbon 3d is conveyed to the take-up roller 3f.

Referring to FIG. 17, the ink ribbon 3d of the heat-insulating ink includes a base member 401. On one surface of the base member 401, a release layer 402 detached from the base member 401 after forming the image of the heat-insulating ink on the medium M, a heat-insulating ink layer 403 which contains a foaming resin such as a polyethylene terephthalate containing a foaming agent and a heat-sensitive boding layer 404 for bonding the heat-insulating ink layer 403 to the medium M are laminated in the named order. On the other surface of the base member 401, a heat-resistant slipping layer 405 with heat resistance and slippage is formed so as to make contact with the head 3a.

When the heat-insulating ink layer 403 is bonded to the medium M, the ink ribbon 3d is heated by the head 3a in a state that the ink ribbon 3d and the medium M are nipped between the head 3a and the conveying roller 4. As a result, the heat-sensitive boding layer 404 of the ink ribbon 3d positioned in an opposing relationship with the head 3a is melted and bonded to the medium M. Then, the ink ribbon 3d is moved along with the conveyance of the medium M and subsequently detached from the medium M. Consequently, the heat-insulating ink layer 403 and the release layer 402 on the heat-sensitive boding layer 404 bonded to the surface of the medium M are detached from the base member 401, whereby the heat-insulating ink layer 403 is formed on the surface of the medium M. Thereafter, the medium M having the heat-insulating ink layer 403 is moved through the foaming unit 3e holding a heater therein. The heat-insulating ink layer 403 formed on the medium M is heated and foamed into a foam layer. The heater of the foaming unit 3e includes a fixing roller as a heat source and a rubber roller arranged in an opposing relationship with the fixing roller. As the medium M is nipped and moved between the fixing roller and the rubber roller, the heat-insulating ink layer 403 formed on the medium M is heated and foamed.

In the present embodiment, the heater of the foaming unit 3e is configured to form a foam layer by heating and foaming the heat-insulating ink layer 403 formed on the medium M to such an extent that the coloring of the temperature-sensitive ink images (or the letters formed by the temperature-sensitive ink) covered with the foam layer can be identified. It is preferred that the foam layer formed by heating the heat-insulating ink layer 403 be colorless and transparent.

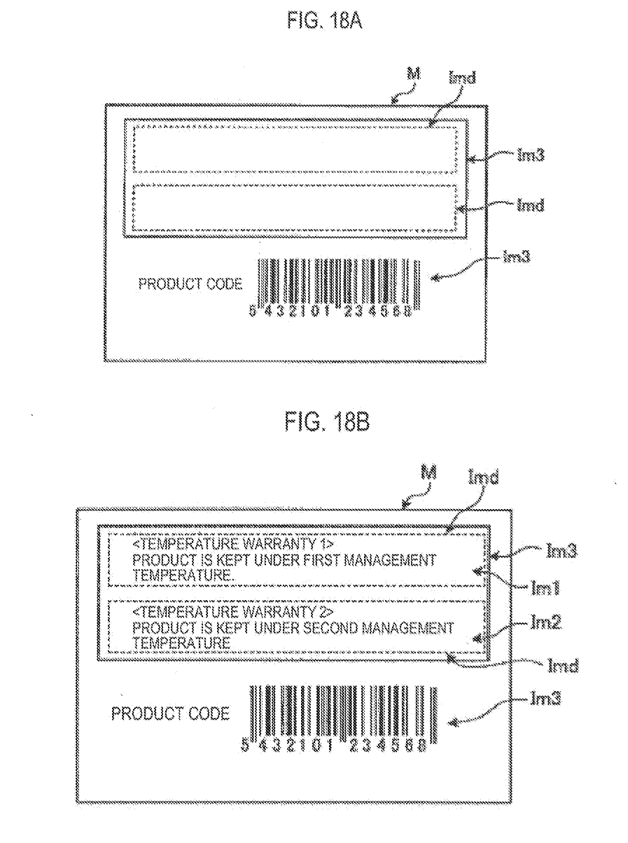

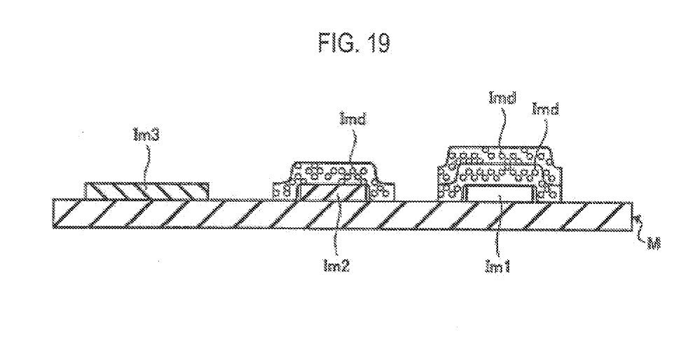

With the printer 1 of the configuration described above, it is possible to obtain, e.g., a medium M as shown in FIGS. 18A, 18B and 19. FIGS. 18A and 18B illustrate one example of a product label as a medium obtained by the printer 1 of the present embodiment. FIG. 19 is a section view showing a product label as a medium obtained by the printer 1 of the present embodiment. FIG. 18A illustrates a product label as a medium M outputted from the printer 1 with no cooling performed by the cooling mechanism 10. FIG. 18B illustrates a product label as a medium M outputted from the printer 1 with cooling performed by the cooling mechanism 10.

In the product label (medium M) illustrated in FIGS. 18A and 18B, there is formed an image Im3 of a typical non-temperature-sensitive ink (e.g., a resin-based ink) whose coloring state is not changed depending on a temperature (e.g., a barcode or a background). The image of the non-temperature-sensitive ink is formed by the ink ribbon cartridge 3D arranged at the most upstream side in the conveying direction of the medium M, one of the ink ribbon cartridges 3 (3A through 3D) mounted to the printer 1.

In the product label (medium M) illustrated in FIGS. 18A and 18B, there are also formed images Im1 and Im2 of a temperature-sensitive ink whose coloring state is changed depending on a temperature (e.g., a metamo ink whose coloring state is changed at 10 degrees Celsius). The temperature-sensitive ink images Im1 and Im2 are images formed by two kinds of temperature-sensitive inks differing in the threshold temperature Th. In the present embodiment, the temperature-sensitive ink images Im1 and Im2 are formed by the ink ribbon cartridges 3C and 3B positioned second and third from the ink ribbon cartridge 3D arranged at the most upstream side in the conveying direction of the medium M, two of the ink ribbon cartridges 3 (3A through 3D) mounted to the printer 1.

In the product label (medium M) illustrated in FIGS. 18A and 18B, a foam layer Imd obtained by heating and foaming a heat-insulating ink (e.g., a heat-insulating ink formulated by mixing a foaming agent with a resin such as polyethylene terephthalate) is formed as a transparent heat-insulating layer with a thermal insulation property so as to cover the temperature-sensitive ink images Im1 and Im2. Since the temperature-sensitive ink images Im1 and Im2 do not make direct contact with the ambient air, it is possible to prevent the temperature-sensitive ink images Im1 and Im2 from undergoing a color change otherwise caused by a momentary temperature change. The foam layer Imd is formed by the ink ribbon cartridge 3A arranged at the most downstream side in the conveying direction of the medium M, one of the ink ribbon cartridges 3 (3A through 3D) mounted to the printer 1.

In the product label illustrated in FIGS. 18A and 18B, a single foam layer Imd is formed over the temperature-sensitive ink images Im1 and Im2. In order to enhance the thermal insulation effect provided by the foam layer Imd, a plurality of foam layers Imd may be repeatedly formed over the temperature-sensitive ink images Im1 and Im2 to increase the thickness of the foam layer Imd (or the heat-insulating layer) formed over the temperature-sensitive ink images Im1 and Im2. Alternatively, as shown in FIG. 19, a single foam layer Imd may be formed over the image Im1 of the temperature-sensitive ink and a plurality of foam layers Imd may be repeatedly formed over the image Im2 of the temperature-sensitive ink whose color is more easily changed than the color of the temperature-sensitive ink used in forming the image Im1 of the temperature-sensitive ink.

In the product label illustrated in FIGS. 18A and 18B, the foam layer Imd is formed to cover the images Im1 and Im2 formed by the temperature-sensitive ink. It is only necessary that at least the images Im1 and Im2 formed by the temperature-sensitive ink be covered with the foam layer Imd. For example, the foam layer Imd may be formed to cover the entire surface of the product label on which temperature-sensitive ink images Im1 and Im2 are formed.

In the printer 1 of the present embodiment, the product label illustrated in FIG. 18A is cooled by the cooling mechanism 10 to visualize the temperature-sensitive ink images Im1 and Im2 as illustrated in FIG. 18B. This enables a user or a worker to visually recognize the temperature-sensitive ink images Im1 and Im2 formed on the medium M.

The temperature-sensitive ink images Im1 and Im2 illustrated in FIGS. 18A and 18B are formed over the non-temperature-sensitive ink image Im3. If the non-temperature-sensitive ink image Im3 is used as a background, the colors of the temperature-sensitive ink images Im1 and Im2 can be more clearly visualized than when the medium M is used as a background. The color of the non-temperature-sensitive ink image Im3 and the colors of the temperature-sensitive ink images Im1 and Im2 may be set in many different combinations. For example, it may be possible to set a combination of mutually complementary colors or a combination of colors with different brightness or different saturation.

If the temperature-sensitive ink images Im1 and Im2 have a property of transmitting visible rays, the images Im1 and Im2 can be visualized with a color obtained by mixing the colors of the temperature-sensitive ink images Im1 and Im2 and the color of the non-temperature-sensitive ink image Im3.

When the temperature-sensitive ink images Im1 and Im2 are formed by two kinds of temperature-sensitive inks differing in the threshold temperatures Th1 and Th2 as set forth above, the ink ribbon cartridges 3 for forming the temperature-sensitive ink images Im1 and Im2 are independently mounted to the body unit 1a because the inks used differ from each other.

In order for the printer 1 to form the temperature-sensitive ink images Im1 and Im2 on the medium M having the non-temperature-sensitive ink image Im3 formed thereon, the ink ribbon cartridge 3 (e.g., the ink ribbon cartridge 3D) for forming the non-temperature-sensitive ink image Im3 is arranged at the upstream side of the conveyance path P and the ink ribbon cartridges 3 (e.g., the ink ribbon cartridges 3B and 3C) for forming the temperature-sensitive ink images Im1 and Im2 are arranged at the downstream side of the ink ribbon cartridge 3D along the conveyance path P. The ink ribbon cartridge 3 (e.g., the ink ribbon cartridge 3A) for forming the foam layer Imd is arranged at the downstream side of the ink ribbon cartridges 3 for formation of the temperature-sensitive ink images Im1 and Im2 along the conveyance path P.

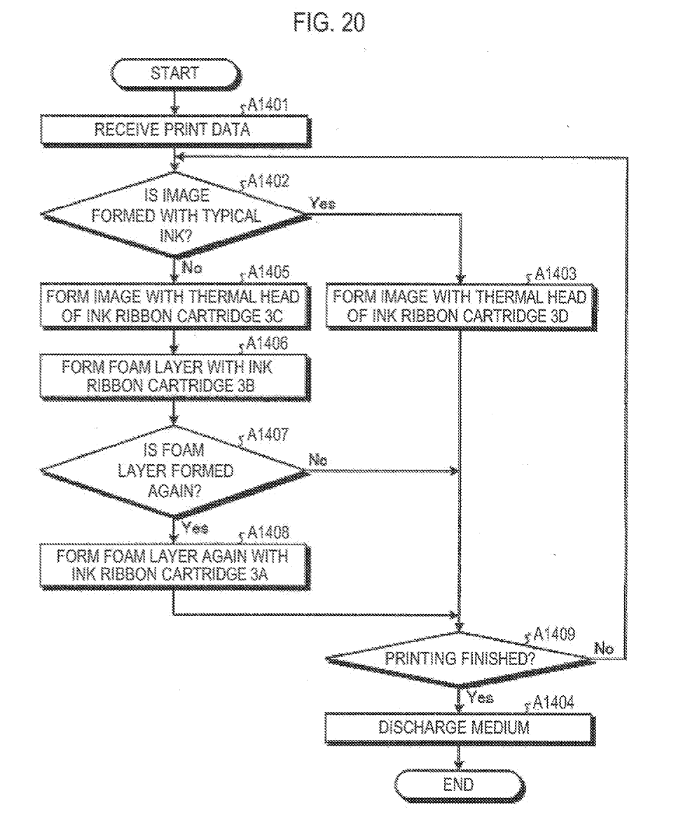

Next, a flow of a process for forming images such as letters or pictures on the medium M under the operation of the print control unit 21a will be described with reference to FIG. 20. In the process illustrated in FIG. 20, the images of the typical ink (non-temperature-sensitive ink) are formed by the ink ribbon cartridge 3D, the images of the temperature-sensitive ink are formed by the ink ribbon cartridge 3C (the image forming unit), and the foam layer (heat-insulating layer) is formed by the ink ribbon cartridges 3B and 3A (the heat-insulating layer forming unit).

If print data supplied from an external device connected through a telecommunication line are received via the communication interface (I/F) 20e (Act A1401), the print control unit 21a analyzes the print data thus received and determines whether to form images with a typical ink (Act A1402). If it is determined that images are to be formed with a typical ink (if Yes in Act A1402), the print control unit 21a causes the head 3a of the ink ribbon cartridge 3D to form images of a typical ink on the medium M (Act A1403). If the printing of the received print data is finished (if Yes in Act A1409), the medium M having the typical ink images formed thereon is discharged (Act A1404). If the printing of the received print data is not finished (if No in Act A1409), the flow is returned to Act A1402.

On the other hand, if it is determined that images are to be formed with a temperature-sensitive ink (if No in Act A1402), the print control unit 21a causes the head 3a of the ink ribbon cartridge 3C to form images with a temperature-sensitive ink on the medium M (Act A1405), while causing the ink ribbon cartridge 3B to form a foam layer so as to cover the temperature-sensitive ink images formed on the medium M (Act A1406).

Then, the print control unit 21a determines whether to repeatedly form an additional foam layer over the foam layer formed by the ink ribbon cartridge 3B (Act A1407). For example, if the temperature-sensitive ink used in forming the images with the head 3a of the ink ribbon cartridge 3C is a temperature-sensitive ink whose color is easily changed by a momentary temperature change, the print control unit 21a determines that an additional foam layer needs to be repeatedly formed over the foam layer formed by the ink ribbon cartridge 3B.

If it is determined that there is no need to repeatedly form an additional foam layer over the foam layer formed by the ink ribbon cartridge 3B (if No in Act A1407) and if the printing of the received print data is finished (if Yes in Act A1409), the print control unit 21a discharges the medium M on which a single foam layer is formed (Act A1404).

In the meantime, if it is determined that an additional foam layer needs to be repeatedly formed over the foam layer formed by the ink ribbon cartridge 3B (if Yes in Act A1407), the print control unit 21a causes the ink ribbon cartridge 3A to repeatedly form an additional foam layer over the foam layer formed by the ink ribbon cartridge 3B (Act A1408). If the printing of the received print data is finished (if Yes in Act A1409), the print control unit 21a discharges the medium M in which two foam layers are formed over the temperature-sensitive ink images (Act A1404).

According to the printer 1 of the present embodiment described above, the head 3a of the ink ribbon cartridge 3C as an image forming unit forms the temperature-sensitive ink images on the medium M. The head 3a and the foaming unit 3e of each of the ink ribbon cartridges 3A and 3B as a heat-insulating layer forming unit form the heat-insulating layer with a thermal insulation property so as to cover at least the temperature-sensitive ink images formed on the medium M. This makes it possible to prevent the temperature-sensitive ink images from undergoing a color change even when a temperature is changed within a short period of time. Accordingly, it becomes possible to provide a label that can be effectively used as a temperature management means.

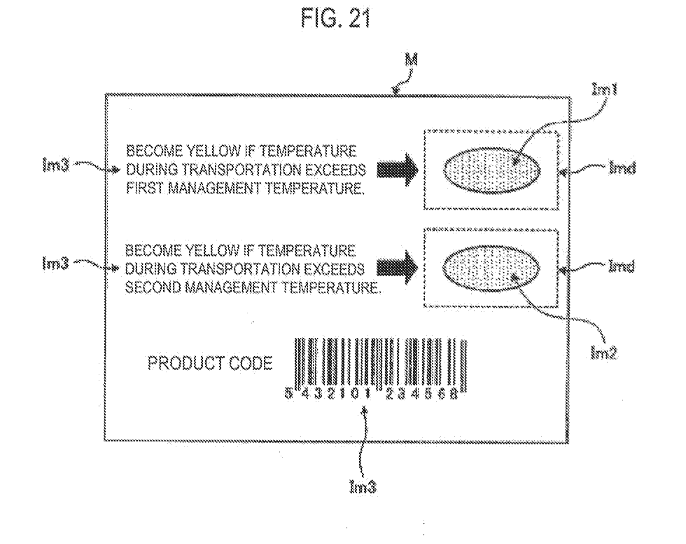

In the printer 1 of the present embodiment, it is also possible to use a temperature-sensitive ink having a property opposite to the property of the temperature-sensitive ink stated above, namely a temperature-sensitive ink having such a property that the temperature-sensitive ink is visualized when the temperature thereof exceeds a management temperature. FIG. 21 is a view showing one example of a product label as a medium obtained in the printer according to a modified example of the third embodiment. For example, as shown in FIG. 21, images Im1 and Im2 of a temperature-sensitive ink whose color is changed to a yellow color indicating the excess of a management temperature when temperature exceeds a threshold temperature are formed in the medium M as a product label. Moreover, a foam layer Imd is formed in the medium M as a product label so as to cover the temperature-sensitive ink images Im1 and Im2. In this example, it is possible to manage a product at different temperatures because the images Im4 and Im5 of temperature-sensitive inks differing in the threshold temperature are formed on the medium M. In the printer 1 corresponding to the example shown in FIG. 21, a heating mechanism instead of the cooling mechanism 10 can be provided as the coloring conversion mechanism. In this example, it is also possible to form the temperature-sensitive ink images Im1 and Im2 over the non-temperature-sensitive ink image formed on the medium M. In this example, the temperature-sensitive ink images Im1 and Im2 are visualized to issue a caution notice or a warning notice when a specified temperature condition is not satisfied.

The printer of the fourth embodiment includes a plurality of cooling mechanisms as a coloring conversion mechanism for converting the coloring states of temperature-sensitive ink images formed on a medium. Hereinafter, description will be made on points differing from the above-described embodiments with no description given on the same points as those of the above-described embodiments.

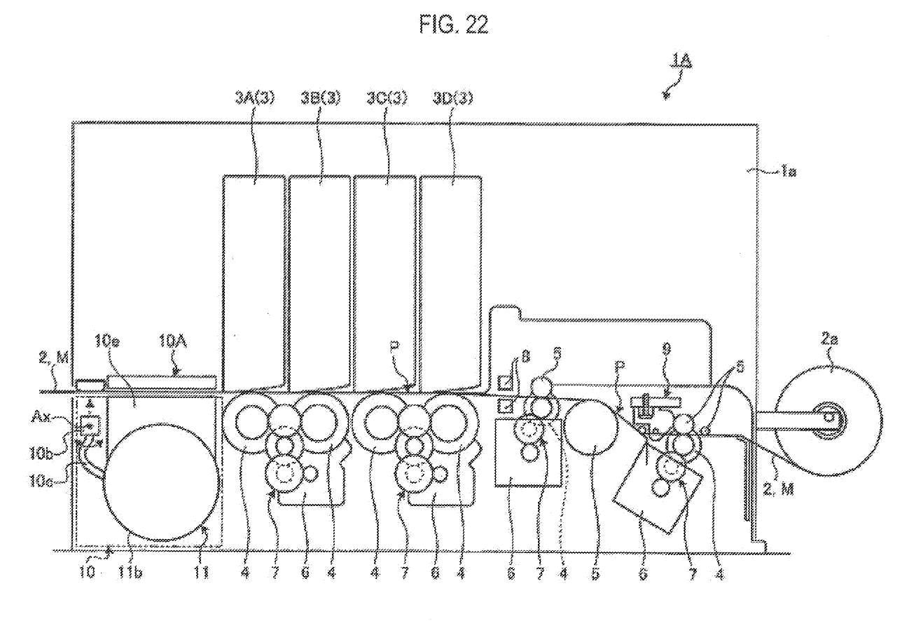

Referring to FIG. 22, the printer 1A of the present embodiment includes not only the cooling mechanism 10 but also a cooling element 10A as a second cooling mechanism. The cooling element 10A may be composed of, e.g., a Peltier element, and is controlled by a cooling element controller 20p as indicated by broken lines in FIG. 6. In this configuration, the cooling temperature of the medium M (the temperature-sensitive ink images) can be finely set by selectively using (one of) the cooling mechanism 10 and the cooling element 10A, using the cooling mechanism 10 and the cooling element 10A in combination or adjusting the cooling performance thereof. When images with different temperature-sensitive inks are formed on the medium M, the efficiency of the coloring conversion performed through a cooling operation can be increased by matching the cooling mechanism 10 and the cooling element 10A with the respective temperature-sensitive inks. The printer may include a plurality of cooling mechanisms of the same type.

In the fifth embodiment, a printer and a coloring conversion mechanism for converting the coloring states of temperature-sensitive ink images formed on a medium by the printer are arranged independently of each other. Hereinafter, description will be made on points differing from the above-described embodiments with no description given on the same points as those of the above-described embodiments.

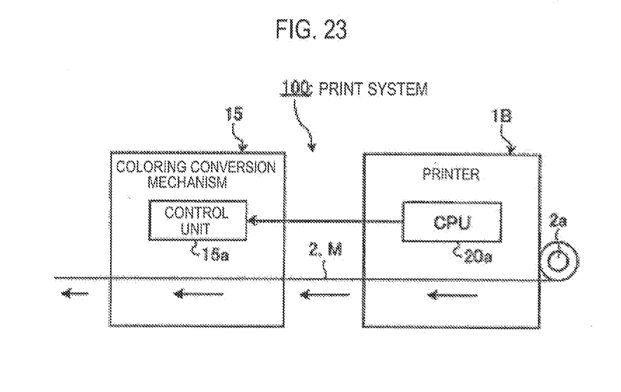

Referring to FIG. 23, a print system 100 of the present embodiment includes a printer 1B and a coloring conversion mechanism 15 for converting the coloring states of temperature-sensitive ink images formed on a medium M by the printer 1B. The coloring conversion mechanism 15 includes at least one of a cooling mechanism and a heating mechanism. In the print system 100, the printer 1B and the coloring conversion mechanism 15 are not unified with each other but are arranged independently of each other. An electric signal is transmitted from a CPU 20a as a control unit of the printer 1B to a control unit 15a of the coloring conversion mechanism 15. Responsive to the electric signal, the coloring conversion mechanism 15 performs a coloring conversion process. The electric signal may be a signal instructing the execution of coloring conversion, a signal indicating the timing of execution of coloring conversion or a signal indicating an execution parameter of coloring conversion.

While certain preferred embodiments have been described above, the present disclosure is not limited thereto but may be modified in many different forms. For example, the printer may include three or more image forming units for forming images with different temperature-sensitive inks. The printer may include both the cooling mechanism and the heating mechanism as the coloring conversion mechanism. In this case, one of the cooling mechanism and the heating mechanism may be caused to act on the temperature-sensitive ink images to first bring the images into an easy-to-see (visible) state. Thereafter, the other may be caused to act on the temperature-sensitive ink images to bring the images into a hard-to-see (invisible) state (namely, to return the images to the original state). This enables a worker or other persons to confirm the temperature-sensitive ink images in the easy-to-see (visible) state. The number of the cooling mechanism and the heating mechanism may be changed to many other numbers.

The printer may include a spouting portion for spouting a cold gas or a hot gas as the cooling mechanism or the heating mechanism. A cold gas or a hot gas can be fed from the outside to the spouting portion through a connector and a pipe. In this configuration, it is possible to omit the gas cartridge, which makes it possible to reduce the size of the printer proportionate to the omission of the gas cartridge.

The printer may be configured from a printer of other type using an ink (e.g., an inkjet printer). In case of the inkjet printer, an ink head corresponds to the image forming unit.

The specifications (type, structure, shape, size, arrangement, position, number, constituent or temperature-sensitive property) of the respective components (the print system, the printer, the medium, the ink ribbon cartridge, the image forming unit, the coloring conversion mechanism, the cooling mechanism, the heating mechanism, the spouting condition adjusting mechanism, the coloring conversion device, the image or the temperature-sensitive ink) may be appropriately modified and embodied.

According to the embodiments and the modified examples described above, it is possible to provide a printer and a print system in which, when forming temperature-sensitive ink images on a medium, trouble is hardly caused due to the color change of a temperature-sensitive ink.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus, or can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

The programs executed in the printers of the present embodiments are configured into modules including the respective units described above (e.g., the print control unit 21a, the coloring conversion setting unit 21b, the counter unit 21c, the determination unit 21d and the coloring conversion control unit 21e). In an actual hardware, the CPU (or the processor) reads out the programs from the ROM and then executes the programs, whereby the respective units are loaded to a main memory unit so that the print control unit 21a, the coloring conversion setting unit 21b, the counter unit 21c, the determination unit 21d and the coloring conversion control unit 21e can be generated in the main memory unit.

While certain embodiments have been described, these embodiments have been presented by way of example only, and are not intended to limit the scope of the inventions. Indeed, the novel printer and print system described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer, comprising:
a conveying mechanism configured to convey a medium;
a first image forming unit configured to form, on the medium, an image with a temperature-sensitive ink whose color changes depending on temperature; and
a coloring conversion mechanism configured to convert a coloring state of the image formed with the temperature-sensitive ink by heating or cooling the image.

2. The printer of claim 1, further comprising:
a second image forming unit configured to form an image of a non-temperature-sensitive ink whose color does not change depending on temperature, on the medium on which the image is formed with the temperature-sensitive ink.

3. The printer of claim 1, further comprising:
a heat-insulating layer forming unit configured to form a heat-insulating layer with a thermal insulation property on the medium so as to cover at least the image formed with the temperature-sensitive ink.

4. The printer of claim 1, wherein the coloring conversion mechanism includes a cooling mechanism configured to spout a gas and reduce a temperature of the image formed with the temperature-sensitive ink.

5. The printer of claim 4, further comprising:
a spouting condition adjusting mechanism configured to adjust a spouting condition of the gas spouted by the cooling mechanism.

6. The printer of claim 1, wherein the first image forming unit includes a plurality of ink ribbon cartridges configured to form images with different temperature-sensitive inks on the medium.

7. The printer of claim 1, wherein the coloring conversion mechanism is configured to convert the coloring state of the image formed with the temperature-sensitive ink.

8. The printer of claim 2, wherein the second image forming unit is configured to form the image of the non-temperature-sensitive ink in a state that at least a portion of the image formed with the temperature-sensitive ink is covered with the image formed with the non-temperature-sensitive ink.

9. The printer of claim 8, wherein the non-temperature-sensitive ink is a wax type ink and the temperature-sensitive ink is a wax-resin type ink or a resin type ink.

10. The printer of claim 8, wherein the image formed with the non-temperature-sensitive ink covers the image formed with the temperature-sensitive ink in a visually unrecognizable condition.

11. The printer of claim 3, wherein the heat-insulating layer forming unit is configured to form, as the heat-insulating layer, a foam layer by forming an image formed with a heat-insulating ink with a thermal insulation property containing a resin and a foaming agent so as to cover the image formed with the temperature-sensitive ink and then heating and foaming the image formed with the heat-insulating ink.

12. The printer of claim 11, wherein the heat-insulating layer forming unit is configured to form the foam layer by foaming the image formed with the heat-insulating ink to such an extent that the image formed with the temperature-sensitive ink can be identified.

13. The printer of claim 11, wherein the heat-insulating layer forming unit is configured to form, as the image formed with the heat-insulating ink, an image of polyethylene terephthalate containing a foaming agent.

14. The printer of claim 3, wherein the heat-insulating layer forming unit is configured to repeatedly form a plurality of heat-insulating layers on the medium so as to cover the image formed with the temperature-sensitive ink.

15. A print system, comprising:
a printer including an image forming unit configured to form, on a medium, an image with a temperature-sensitive ink whose color changes depending on temperature; and
a coloring conversion device including a coloring conversion mechanism configured to convert a coloring state of the image formed with the temperature-sensitive ink in response to a signal received from the printer.

16. The system of claim 15, wherein the printer further includes a second image forming unit configured to form an image of a non-temperature-sensitive ink whose color does not change depending on temperature, on the medium on which the image is formed with the temperature-sensitive ink.

17. The system of claim 16, wherein the printer further includes a heat-insulating layer forming unit configured to form a heat-insulating layer with a thermal insulation property on the medium so as to cover at least the image formed with the temperature-sensitive ink.

18. The printer of claim 1, wherein the first image forming unit further comprises:
an ink ribbon holding unit configured to hold an ink ribbon applied with a temperature-sensitive ink whose color changes depending on temperature;
a ribbon conveying unit configured to convey the ink ribbon held by the ink ribbon holding unit; and
a thermal head configured to form an image with the temperature-sensitive ink on a medium by heating the temperature-sensitive ink.

19. A printing method, comprising:
receiving print data from an external device;
forming an image with a temperature-sensitive ink on a medium; and
forming a first foam layer to cover the image with the temperature-sensitive ink formed on the medium.

20. The method of claim 19, further comprising:
forming a second foam layer over the first foam layer formed on the medium.
